(19) United States
(12) Patent Application Publication
(10) Pub. No.: US 2004/0117639 A1
(43) Pub. Date: Jun. 17, 2004

(54) Secure driver

(76) Inventor: Keith R. Mowery, Plano, TX (US)

Correspondence Address: TEXAS INSTRUMENTS INCORPORATED, P O BOX 655474, M/S 3999, DALLAS, TX, 75265

(21) Appl. No.: 10/321,338

(22) Filed: Dec. 17, 2002

(51) Int. Cl. H04L 9/32

(52) U.S. Cl. 713/187

(57) ABSTRACT

A secure computer driver utilizes encrypted instructions stored on a hard drive. The encrypted instructions are retrieved line by line of code and decrypted in the secure area of the CPU utilizing decryption instructions stored in the BIOS integrated circuit memory.

### CROSS REFERENCE TO RELATED APPLICATION

This reference is related to commonly owned co-pending application Ser. No. ______ (T35304) entitled “SECURE MEDIA CARD OPERATION OVER AN UNSECURED PCI BUS” filed on even date and incorporated herein by reference.

### FIELD OF THE INVENTION

This application is related to a driver for a computer and more specifically to a driver for a computer which generates commands for a media card connected to the PCI bus.

### BACKGROUND OF THE INVENTION

FLASH media cards are becoming a popular way of storing an exchanging information and this will increase as the price of the cards per megabit of memory continues to drop. It is thus economically feasible to distribute data such as audio or video recordings utilizing this media instead of using compact discs (CDs) or DVDs. The data stored on the media card would be encrypted utilizing an encryption function to prevent unauthorized access to the information.

The above reference of co-pending application relates to reading a memory card over an unsecured computer bus and more specifically to a secure method for reading secured data from a FLASH media card over an unsecured PCI bus. The technique in the application is to move the command structure generation from the FLASH media core to the CPU of the computer system into which the media card is plugged in. The technique provides secured commands across the PCI bus by encrypting the commands in the driver, sending the encrypted commands over the PCI bus to an encryption/decryption module in which they are decrypted and then sending the decrypted commands to the FLASH media card. When the media card is providing the encrypted data stored therein, the encrypted data is sent across the PCI bus to the CPU and the driver returns the information back across the PCI bus either in a double encrypted form in which case it goes to the encryption/decryption module to the FLASH media core, or in the original encrypted form in which case it goes to the FLASH media core bypassing the encryption/decryption module. The FLASH media core decrypts the data stored on the FLASH media card utilizing a proprietary decryption function, sends this to be encrypted utilizing the second encryption function in the encryption/decryption module which is then sent in the encrypted form across the PCI bus to the CPU. The CPU then decrypts the information from the second encryption function and sends the data to a utilization device such as a sound and/or video card. In this manner, all of the information that crosses the PCI bus is in at least one encrypted form, which precludes unauthorized access.

A potential problem with this solution is in the implementation of the computer driver itself. Normally, the instructions for the computer driver would be stored in the hard drive although they could be stored in a nonvolatile integrated circuit memory as well. In either case, the instruction could be read from the storage device either during the operation of the driver or off line. Once the command structure is known, unauthorized persons could gain access to the encrypted information stored on the media card. Accordingly, a method for securing the computer driver would preclude or make more difficult such unauthorized access.

### SUMMARY OF THE INVENTION

A general object of the invention is to provide a secure computer driver.

This and other objects and features are provided, in accordance with one aspect of the invention by a computer system comprising a series of first instructions stored in a storage device, the instructions having been encrypted utilizing a first encryption function to form first encrypted instructions. A memory device has instructions for decrypting the first encrypted instructions. A CPU is coupled to the storage device and the memory device for decrypting the first encrypted instructions in a protected area of the CPU to form first decrypted instructions.

Another aspect of the invention includes a secure transmission path across an unsecured bus in which encrypted data or commands are transferred between a CPU and a peripheral device. A computer driver comprises a series of first instructions stored in a storage device, the instructions having been encrypted utilizing a first encryption function to form first encrypted instructions. A series of second instructions stored in a memory device for decrypting the first encrypted instructions to generate first decrypted instructions, the first decrypted instructions operating the CPU to receive data or instructions from transmit data or instructions to the peripheral device, whereby all data and commands transmitted across the unsecured bus are encrypted.

A further aspect of the invention is provided by a method for secure transmission across an unsecured bus between a CPU and a peripheral device. Operating the CPU utilizing second instructions stored in BIOS to retrieve first encrypted instructions from a storage device. Decrypting the first encrypted instructions in a protected area of the CPU under the control of the second instructions to generate first decrypted instructions. Generating commands to the peripheral device using the first decrypted instructions to control the CPU.

### BRIEF DESCRIPTION OF THE DRAWINGS

FIG. 1 shows a block diagram of a computer system incorporating the present invention; and

FIG. 2 shows a flow chart for a computer program implementing the secure driver of the present invention.

### DETAILED DESCRIPTION OF THE PRESENT INVENTION

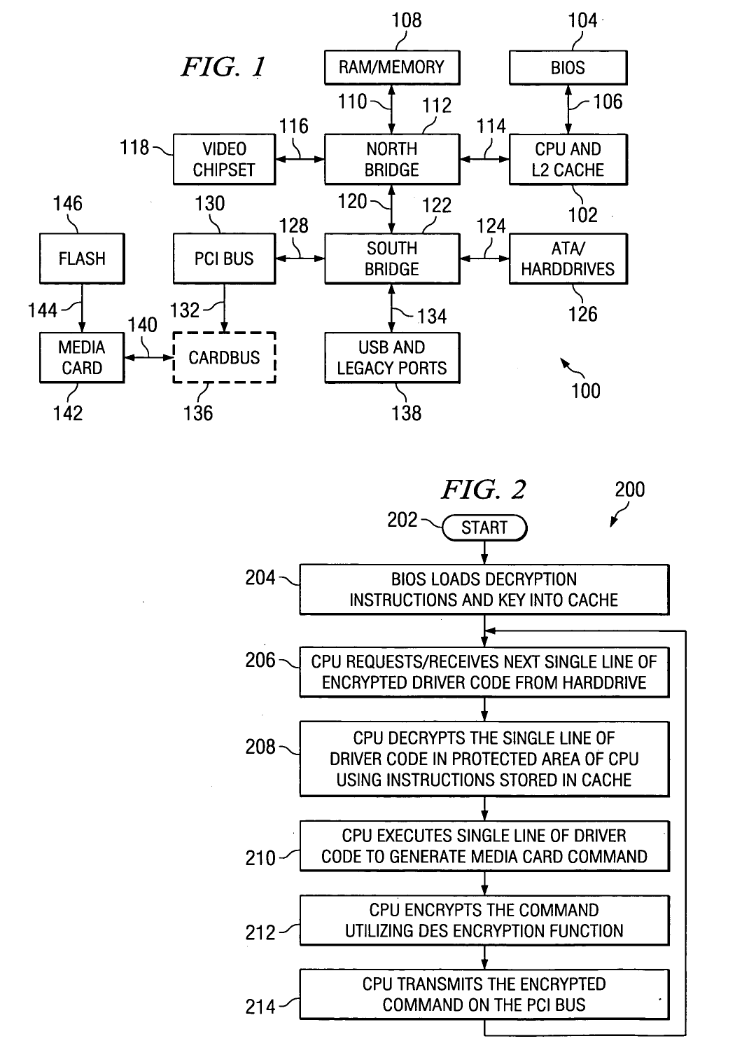

FIG. 1 shows a block diagram for a computer system in accordance with the present invention generally as 100. The CPU has an L2 cache and the computer chip set includes a “north bridge” 112 coupled to the CPU via bus 114 and a “south bridge” coupled to the north bridge by serial bus 120, as are all well known in the art. A RAM memory 108 is coupled to the north bridge via a bus 110 and utilization devices 118, shown here as a video chip set, which could also be an audio or audio/video chip set, connected to the north bridge via bus 116. The hard drive for the computer system is illustrated as an ATA hard drive 126 which is coupled to the south bridge via ATA bus 124. The south bridge is coupled via bus 134 to such ports as USB ports, parallel or serial ports (shown in the figure as legacy ports) 138. A PCI bus 130 is coupled via bus 128 to the south bridge 122. The PCI bus may be coupled via bus 132 to a Card bus 136, known in the art, which can then be coupled via bus 140 to the media card 142. In the system illustrated in the co-pending application, the media card is connected directly to the PCI bus. Accordingly, the Card bus 136 is illustrated in dotted lines. The media card 142 includes the media card interface and decryption circuit shown in the co-pending application as well as the circuitry necessary to interface with the PCI bus. Coupled to the media card interface circuitry is a FLASH memory 146 which contains the keys necessary for the encryption/decryption function that are utilized in connection with the co-pending application.

The CPU 102 is coupled via bus 106 to a BIOS 104 which is typically stored in a FLASH memory, so the BIOS can be reloaded with updated version when necessary.

With the exception of elements 132, 136, 140, 142, 144 and 146, the system shown in FIG. 1 is a commonly used computer architecture and is well known in the art. Card bus interfaces such as card bus 136 are also well known in the art. The operation of the media card and its interface and the encryption/decryption circuits, including the utilization of FLASH memory 146, is described in more detail in the co-pending application. In the co-pending application the FLASH memory 146 corresponds to the EEPROM 254.

The CPU of this commonly utilized computer architecture loads instructions from the BIOS stored in the FLASH memory 104 upon start up. In addition, when the CPU has a “protected area” within the device which allows operations to be performed secure from attempts to read the operations from outside the chip. If the chip detects an effort to read this information, the CPU shuts down the chip in order to safe guard the information. This feature is utilized in the present invention.

In the present invention, the driver which will be described below is stored on the hard drive in an encrypted form. It is also possible to store the driver in the RAM memory 108, although this is not normally done because the RAM memory is a volatile memory and its contents will be lost once the computer is shut off. The driver stored on the hard drive may be encrypted using one of the Data Encryption Standard (DES) functions known in the art, such as the DES encryption function utilized in the co-pending application. The encryption makes it more difficult for unauthorized users to gain access to the instructions of the media driver and thus gain access to the encrypted contents stored on the media card. However, it is necessary that the CPU have unencrypted instructions in order to operate.

Operation of the present invention will be now be described in connection with FIGS. 1 and 2. In FIG. 2, upon start up of the system, the BIOS loads initial operating instructions into the CPU and the decryption instructions and the key utilized with the decryption instructions (explained in detail in the co-pending application) are stored into the into the L2 cache on the CPU integrated circuit at step 204. When it is necessary to generate a command for the media card, which may be a command for the card to send encrypted content over the PCI bus to the CPU, the CPU requests the next single line of instruction in the encrypted driver stored on the hard drive 126 and the single line of instructions is sent from the hard drive to the south bridge and the north bridge to the CPU at 106. Only a single line of code is sent at any given time, which makes it more difficult for an unauthorized person to gain access to the entire driver.

The CPU decrypts the single line of driver code in the protect area of the CPU utilizing the instruction stored in the L2 cache. Because the encryption occurs in the protected area of the CPU, it is secured then unauthorized access and the CPU will shut down if there are unauthorized attempts to read the code in this protected area of the CPU. This occurs at step 208. Once the instructions have been decrypted, the CPU executes the decrypted instructions just as if the instructions had not been encrypted. In block 210 of FIG. 2, this is shown as executing a single line of computer code to generate a media card command. As is well known to those skilled in the art, it is possible for a single line of code to generate more than a single command and it is possible that multiple lines of code are needed to generate a single command. The CPU then encrypts the command that has been generated utilizing a second encryption function which is a second DES encryption function. This encryption function must match the encryption function utilized by the media card circuitry 142 as more fully described in the co-pending application. This second encrypted command is then transmitted across the PCI bus to the media card interface circuit 142. Once a single line of code has been encrypted and executed, the CPU then requests and receives the next single line of encrypted driver code from the hard drive 126.

The utilization of an encrypted driver stored on hard drive 126 and decrypted by code stored in the FLASH memory 104 containing the BIOS, which is considered secure, and performing with encryption function in the protected area of the CPU 102 constitutes a security technique which makes access to the instructions that generate the function commands to the media card difficult for an unauthorized user to obtain.

Operation of the media card reader is described in detail in the co-pending application. A simplified description is provided below. The CPU generates a command and then encrypts it utilizing the same DES encryption function utilized by the encryption/decryption circuit of the media card interface circuitry. The encrypted command is sent via the north and south bridges to the PCI bus and then on to the media card interface circuit which contains a DES encryption/decryption circuit. The encrypted command is then encrypted and utilized to command a media card to perform a predetermined function. That function may be providing encrypted data stored on the card, for example. The encrypted data is then sent directly to the PCI bus and through the south and north bridges to the CPU. Because they are already in the encrypted form, no further encryption is necessary. At this point the CPU can take one of two paths. Because the data stored on the media card is already encrypted, the data may be sent by the CPU back down through the north and south bridges to the PCI bus and to the media core of the media card interface circuit which is a hardware decryption circuit that decrypts the data stored on the card. Alternatively, the CPU can encrypt the encrypted data to provide double encrypted data which can be sent down through the north and south bridges to the PCI bus and to encryption/decryption circuit in the media card interface circuits 142. The double encrypted data will be decrypted by the encryption/decryption circuits to remove the DES encryption and the resulting data, which is still in an encrypted form with the media card encryption, will be decrypted by the media core. The result will be decrypted data; that is, the content of the media card is available in a non-encrypted form. The media core will send the non-encrypted data through the encryption/decryption circuit in which it will be encrypted utilizing the DES encryption function and then sent along the PCI bus back through the south and north bridges to the CPU. The CPU will decrypt the data utilizing the DES decryption function and send in encrypted data via the north bridge to the utilization circuit, such as a video chip set 118. Thus, all information flowing across the PCI bus is in an encrypted form.

While the invention has been particularly shown and described with reference to preferred embodiments thereof, it is well understood by those skilled in the art that various changes and modifications can be made in the invention without departing from the spirit and scope of the invention as defined by the appended claims. For example, the invention is not limited to the particular bus standard, such as a PCI bus, described herein nor is it limited to a particular storage device or particular computer architecture. Encryption techniques other than DES functions can be utilized for both the encryption of the driver code stored on the hard drive and the encryption utilized across the PCI bus.

1. A computer system comprising:
a series of first instructions stored in a storage device, the instructions having been encrypted utilizing a first encryption function to form first encrypted instructions;
a memory device having instructions for decrypting the first encrypted instructions;
a CPU coupled to the storage device and the memory device for decrypting the first encrypted instructions in a protected area of the CPU to form first decrypted instructions.

2. The computer system of claim 1 further comprising a series of second instructions for encrypting the first decrypted instructions in the CPU utilizing a second encryption function to form second encrypted instructions.

3. The computer system of claim 1 wherein the first encryption function is a first DES encryption.

4. The computer system of claim 2 wherein the second encryption function is a second DES encryption.

5. The computer system of claim 1 wherein the storage device is a hard disk drive.

6. The computer system of claim 1 wherein the memory device is a FLASH memory BIOS integrated circuit.

7. The computer system of claim 2 wherein;
the CPU for receives first encrypted data from a peripheral device and
encrypts the first encrypted data utilizing the second encryption function to form second encrypted data.

8. The computer system of claim 7 wherein;
the CPU transmits the second encrypted data across a unsecured bus.

9. The computer system of claim 8 wherein the second encryption function is a DES function and the bus is a PCI bus.

10. The computer system of claim 1 wherein the first encrypted instructions are decrypted on a line at a time basis.

11. In a secure transmission path across an unsecured bus in which encrypted data or commands are transferred between a CPU and a peripheral device, a computer driver comprising:
a series of first instructions stored in a storage device, the instructions having been encrypted utilizing a first encryption function to form first encrypted instructions;
a series of second instructions stored in a memory device for decrypting the first encrypted instructions to generate first decrypted instructions the first decrypted instructions operating the CPU to receive data or instructions from or transmit data or instructions to the peripheral device, whereby all data and commands transmitted across the unsecured bus are encrypted.

12. The computer driver of claim 11 wherein the first instructions are encrypted utilizing a DES encryption function.

13. The computer drive of claim 11 wherein the series second of instructions are stored in BIOS.

14. The computer driver of claim 11 wherein the series second of instructions operate in a secure portion of the CPU.

15. The computer driver of claim 14 wherein the series of first instructions generates commands to operate the peripheral device.

16. The computer driver of claim 11 wherein the series of first instructions generates commands to operate a media card.

17. The computer driver of claim 16 wherein the series of first instructions operates the CPU to receive encrypted data from the media card and transmit the encrypted data to a decryption circuit.

18. A method for secure transmission across an unsecured bus between a CPU and a peripheral device comprising:
operating the CPU utilizing second instructions stored in BIOS to retrieve first encrypted instructions from a storage device;
decrypting the first encrypted instructions in a protected area of the CPU under the control of the second instructions to generate first decrypted instructions; and
generating commands to the peripheral device using the first decrypted instructions to control the CPU.

19. The method of claim 18 further comprising encrypting the commands utilizing a second encryption function to generate second encrypted instructions; and
transmitting the second encrypted instructions to the peripheral device via the bus.

20. The method of claim 18 further comprising receiving encrypted data from the peripheral device in the CPU; and
transmitting encrypted data to a decryption circuit.
